(19) United States
(12) Patent Application Publication
(10) Pub. No.: US 2026/0310948 A1
(43) Pub. Date: Oct. 8, 2026

(54) RUNTIME CONTROL OF INTERNAL ACTIVATION PATHWAYS IN ARTIFICIAL NEURAL NETWORKS

(71) Applicant: Edwin Barton Yeary, Orinda, CA (US)

(72) Inventor: Edwin Barton Yeary, Orinda, CA (US)

(21) Appl. No.: 19/647,620

(22) Filed: Apr. 14, 2026

Related U.S. Application Data
(63) Continuation-in-part of application No. 19/456,964, filed on Jan. 22, 2026.
(63) Continuation-in-part of application No. 19/294,935, filed on Aug. 8, 2025.
(60) Provisional application No. 63/783,952, filed on Apr. 5, 2025.
(60) Provisional application No. 63/926,041, filed on Nov. 26, 2025.

(51) Int. Cl. G06N 3/048; G06N 3/042

(52) U.S. Cl. CPC G06N 3/048; G06N 3/042

(57) ABSTRACT

A computing system is configured to receive, during inference of an artificial neural network processing an input, activation data comprising intermediate numerical representations produced by one or more internal layers of the artificial neural network. The system determines, based on the activation data, an internal activation pathway within the artificial neural network, the internal activation pathway corresponding to a constraint set defining permissible activation behavior. The system generates an output of the artificial neural network based at least in part on the activation data and the constraint set corresponding to the internal activation pathway.

### CROSS-REFERENCE TO RELATED APPLICATIONS

This application claims priority to a U.S. provisional patent application 63/926,041 filed on Nov. 26, 2025. This application is a continuation in part of U.S. patent application Ser. No. 19/456,964 filed Jan. 22, 2026. This application is a continuation in part of U.S. patent application Ser. No. 19/294,935 filed on Aug. 8, 2025, which in turn claims priority to U.S. provisional patent application 63/783,952 filed on Apr. 5, 2025. The contents of the related applications are incorporated by reference in their entirety.

### TECHNICAL FIELD

The present disclosure relates to artificial intelligence (AI) and machine learning (ML), and more specifically, to enhanced control of an artificial neural network (ANN) based on applying a constraint set corresponding to an internal activation pathway of the ANN during inferencing.

### BACKGROUND

AI and ML technology typically refers to computers that have been programmed and/or taught to process data in a manner that resembles human intelligence. Generally, these computers process data, spot patterns, make predictions, and solve problems without being explicitly programmed for every possible scenario. The field continues to grow. AI systems can translate languages, diagnose medical conditions, drive cars, and create written or visual works.

### SUMMARY

Aspects of the present disclosure describe a computing system, method, and non-transitory computer readable medium for controlling the behavior of an artificial neural network during inference through runtime control of internal activation pathways.

In one aspect, a computing system is disclosed. The computing system comprises one or more processors and a memory storing instructions that, when executed by the one or more processors, configure the system to: receive, during inference of an artificial neural network processing an input, activation data comprising intermediate numerical representations produced by one or more internal layers of the artificial neural network; determine, based on the activation data, an internal activation pathway within the artificial neural network, the internal activation pathway corresponding to a constraint set defining permissible activation behavior; and generate an output of the artificial neural network based at least in part on the activation data and the constraint set corresponding to the internal activation pathway.

In some embodiments, the constraint set comprises at least one of: one or more numeric bounds, one or more activation thresholds, a mask, one or more gating coefficients, one or more sparsity targets, or one or more scaling functions.

In some embodiments, generating the output comprises evaluating the activation data against the constraint set corresponding to the internal activation pathway to determine whether the activation data satisfies the constraint set, and modulating, in response to determining that the activation data does not satisfy the constraint set, the activation data of the internal activation pathway, wherein the modulation is performed without modifying stored parameters of the artificial neural network.

In some embodiments, the internal activation pathway comprises one or more activation subgraphs across one or more layers of the artificial neural network, each activation subgraph corresponding to an observed inference behavior of the artificial neural network, and wherein the constraint set comprises one or more constraints assigned to the one or more activation subgraphs based on the observed inference behavior corresponding to each respective activation subgraph.

In some embodiments, the system is further configured to maintain a registry associating the internal activation pathway or one or more activation subgraphs within the internal activation pathway with a unique identifier, and wherein determining the internal activation pathway comprises referencing the registry based on the activation data to obtain the constraint set that corresponds to the internal activation pathway or the one or more activation subgraphs.

In some embodiments, the internal activation pathway is one of a plurality of internal activation pathways within the artificial neural network, each of the plurality of internal activation pathways corresponding to a respective constraint set, and wherein generating the output comprises arbitrating among the plurality of internal activation pathways by weighting respective activation data of each of the plurality of internal activation pathways based on satisfaction of the respective constraint set.

In some embodiments, the internal activation pathway is not associated with a pre-existing constraint set, and the system is further configured to dynamically generate the constraint set for the internal activation pathway based on the activation data observed during the inference.

In some embodiments, stored context accessed by the artificial neural network during the inference is partitioned into a plurality of segments, and the system is further configured to filter the stored context provided to the internal activation pathway by permitting access to a subset of the plurality of segments defined by the constraint set corresponding to the internal activation pathway.

In some embodiments, the constraint set comprises a hierarchical constraint stack including at least a primary constraint and a secondary constraint, wherein the primary constraint comprises a range or threshold of activation among the internal activation pathway, and wherein the secondary constraint comprises a coherence scoring, logical consistency, or tone alignment.

In some embodiments, the system is further configured to generate and store a log comprising one or more of: an identification of the internal activation pathway, a result of evaluating the activation data against the constraint set, or a modulation applied to the activation data.

In another aspect, a method performed by a processing device is disclosed. The embodiments described with respect to the computing system apply equally to the method aspect. In yet another aspect, a non-transitory computer readable medium is disclosed. The non-transitory computer readable medium stores instructions that, when executed by one or more processors, cause the one or more processors to perform the operations described with respect to the computing system and the method.

The foregoing summary is illustrative and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 shows a computer system that controls the behavior of one or more autonomous agents through a control layer, in accordance with some embodiments.

FIG. 2 illustrates a computing system configured to perform runtime control of internal activation pathways within an artificial neural network during inferencing, in accordance with some embodiments.

FIG. 3 shows an example workflow for determining and storing internal activation pathways, in accordance with some embodiments.

FIG. 4 shows an example workflow for evaluating activation data against a constraint set and determining a corrective action, in accordance with some embodiments.

FIG. 5 illustrates memory segmentation and pathway-aware memory selection for controlling internal activation behavior of an artificial neural network during inference, in accordance with some embodiments.

FIG. 6 shows an example method for controlling activation pathways of an artificial neural network, in accordance with some embodiments.

FIG. 7 is one embodiment of a computer system that may be used to support the systems and operations described, in accordance with an embodiment.

### DETAILED DESCRIPTION

Agentic AI refers to artificial intelligence that is configured to operate with a degree of autonomy to achieve goals through decision-making and action-taking, as opposed to simply responding to prompts or performing a strict input/output operation. Agentic AI can make decisions and take actions without constant human direction, operating based on their programming and learned behaviors. Agents work toward specified objectives, whether explicitly programmed or learned through training. They can perceive their environment (digital or physical) and act within it. Actions may include accessing databases, calling APIs to interact with websites or other applications, generating control commands to operate and control machinery or robots, interacting with humans, displaying or processing data, or organizing memory, to name a few. Agents are configured to evaluate situations and choose from multiple possible actions based on their understanding of the current state and desired outcomes. Unlike single-interaction AI systems, agents can be configured to operate continuously over time, maintaining state and context over time and/or over multiple actions. Modern artificial neural networks (ANNs) may serve as the core machine learning model of many AI agents.

An ANN may produce outputs by propagating input data through multiple internal layers, generating intermediate numerical representations (activation data) at each stage of inference. Existing control techniques of an ANN operate primarily at the input level (e.g., prompt filtering) or at the output level (e.g., post-processing responses). These approaches do not provide any mechanism for monitoring, evaluating, or controlling how the model's internal activation pathways behave during inference. As a result, a model may activate internal pathways that are misaligned with desired constraints, inconsistent with domain expectations, or otherwise undesirable for a given task, yet no external system exists to detect or correct such behavior in real time without retraining or permanently altering the model's stored parameters.

The described internal activation control may address several classes of failure modes that would otherwise arise during inference. Runaway activation amplification may occur when a pathway's activation magnitude grows unchecked across layers, leading to disproportionate influence on the output. Latent sycophancy or feedback loops may form when activation patterns reinforce user-pleasing or contextually biased outputs without external checks. Domain leakage between circuits may arise when pathways intended for one functional domain inadvertently influence outputs in unrelated domains. Tone drift across activations may otherwise result in outputs that deviate from an intended behavioral register.

Aspects of the present disclosure describe a system that addresses these shortcomings. During inference of an artificial neural network processing an input, the system receives activation data comprising intermediate numerical representations produced by one or more internal layers of the neural network; determines, based on the activation data, an internal activation pathway within the neural network, the internal activation pathway corresponding to a constraint set defining permissible activation behavior; and generates an output of the neural network based at least in part on the activation data and the constraint set corresponding to the internal activation pathway. In this manner, the system establishes an external, runtime control layer that can identify relevant internal activation pathways, evaluate their activation data against defined constraints, and modulate the model's output accordingly, all without modifying the stored parameters of the trained neural network. This approach enables a more predictable, and more controllable model behavior by bringing constraint-based control to the internal pathway level of the neural network on a per-inference basis.

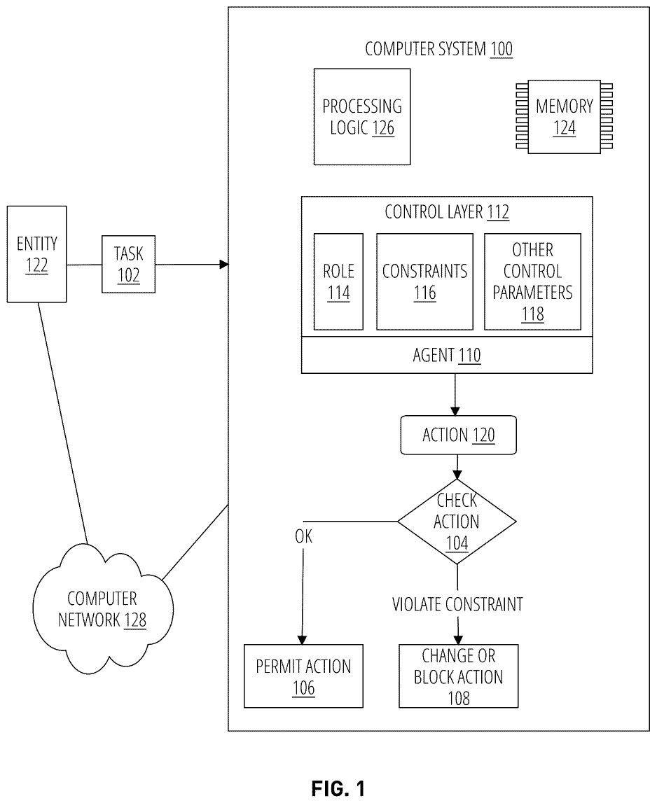

In some embodiments, the system may operate in conjunction with an execution-boundary control layer that enforces admissibility at the moment of action. For example, the internal activation pathway governance may function as a pre-execution admissibility shaping mechanism. By evaluating and modulating activation data during the forward pass, the system may shape the computational state of the artificial neural network before any action or output is finalized. Outputs produced via latent modulation may remain subject to downstream admissibility evaluation at the execution boundary, where a final action may be further evaluated against execution-layer constraints such as those described with respect to FIG. 1.

FIG. 1 shows a computer system that controls the behavior of one or more autonomous agents through a control layer, in accordance with some embodiments.

The computer system 100 includes memory 124, and processing logic 126. Processing logic 126 may comprise one or more processors such as, for example, one or more central processing units (CPUs), and/or one or more graphics processing units (GPUs), and/or other processing devices. Processing logic may include an application, an operating system, a service, a subroutine, embedded instructions or a script, an agent that is governed by a control layer, or a combination thereof. It should be understood that actions described as being performed by processing logic or a computer system throughout the present disclosure, may be interpreted as being performed by the agent, or a service or routine executing separate from the agent, or a combination thereof. Computer system 100 comprises memory 124, which may comprise random access memory (RAM), video RAM (VRAM), cache, disk, solid state drives (SSD), hard disk drives (HDD), or other computer-readable memory. The computer system 100 may be connected to a computer network 128. Computer network 128 may include a collection of interconnected computing devices that can communicate and share resources, such as files, applications, printers, and internet access. Network devices such as routers and switches direct network traffic between different networks, or manage traffic within a single network. Network nodes such as computers, servers, smartphones, and other hardware, are connected via communication links like cables, Wi-Fi, or satellite connections. Computer system 100 may represent a plurality of computer nodes and/or services (e.g., in a microservices application) which may be distributed over the computer network 128 on separate devices, configured to work together to perform the described operations.

Computer system 100 is configured to instantiate a control layer 112 in memory 124, and attaches the control layer 112 to an agent 110. In some embodiments, computer system 100 may load agent 110 to memory 124, where the agent 110 is ready for handling tasks. Prior to instantiation, a control layer may comprise a class or other machine-instantiable data structure, which may include placeholders for control layer parameters that are initialized upon instantiation. The control layer may comprise an application programming interface (API) or other interface that allows the computer system 100, an agent, and/or other services operating in the computer system 100 to communicate with and/or extract parameters from (e.g., role, constraints, etc.).

The control layer 112 may comprise at least a role 114, and constraints 116. The role 114 defines the role of agent 110, such as its functional identity and/or domain of operation. The constraints 116 may comprise one or more constraints, or a plurality of constraints 116.

In some embodiments, computer system 100 forms the constraints 116 as a constraint stack or a hierarchical constraint stack. A hierarchical constraint stack may be constructed as a data structure with elements (e.g., constraints) stored in a tree data structure with parent-child relationships. This means that some constraints serve as parents to others, and this pattern is repeated throughout the structure. By constructing the constraints as a hierarchical stack, processing logic allows for efficient storage, retrieval, and implementation of constraints, while using a natural hierarchical or nested structure that is complementary in defining roles for agents

The constraints 116 define the permissible actions of the agent 110 to which the control layer 112 is attached to. Additional control parameters 118 may be included in the control layer 112 to further modulate agent behavior, such as tone, privilege levels, or escalation logic, as described in other sections.

The computer system 100 may receive a task 102 from an entity 122. The entity 122 may represent an external or internal actor (such as a user, administrator, or another system component) that may interact with the computer system 100 and initiate tasks. In some examples, the computer system 100 and the entity 122 may be one and the same, for example, the computer system 100 may generate one or more tasks to simulate operation of the agent 110 and other system components, as described in other sections. In other examples, the entity 122 may comprise a service, a subroutine, an application, a network node, or other entity that is separate from the computer system 100.

A task 102 is an assignment or objective received by the computer system 100 that requires execution by an agent 110. Tasks 102 can vary widely depending on the domain and the agent's role 114. For example, a task 102 may include generating a summary of data for a client, drafting an email update for a team, generating a control command for operational technology (OT), arranging travel accommodations, processing physical sensor data, determining a vehicle driving route or vehicle actuator commands, or reviewing a document for compliance. Each task may represent a distinct operation or set of operations, with a target outcome, that the system may assign to one or more agents to perform.

The computer system 100 may select agent 110 based on role alignment with task 102. For example, upon receiving a task 102, the computer system 100 evaluates the available agents, which may include those that are already loaded in memory 124, and selects agent 110 for task execution based on the agent's role 114 and its alignment with one or more characteristics of the task 102. For example, if the task 102 is to generate vehicle control commands, and role 114 indicates a corresponding role intended to generate vehicle control commands, computer system 100 selects the agent 110 with attached control layer 112 for the task 102.

The computer system 100 may direct the agent 110 (e.g., through signaling, an application programming interface (API), or other communication means) to process and perform the task 102.

As the agent 110 proceeds to process the task 102 (e.g., as input to the agent's underlying ML model) each proposed action 120 generated by the agent 110 is evaluated by the computer system 100 against the control layer 112 at block 104. It should be understood that the agent itself can be configured to perform the evaluation of its action against the control layer 112, or this functionality may be performed by the larger computer system 100 and one or more services thereof, or a combination thereof.

At block 104, the computer system 100 determines whether the action 120 satisfies all applicable constraints 116 in the constraint stack. If the action 120 is found to violate one or more of the constraints 116, the computer system 100 may block the action 120 or modify the action 120 to ensure compliance before execution. For example, action 120 may include an attempt to execute a structured query to retrieve data from a database as part of a data mining operation. Other examples of action 120 might include sending a network request to a remote system to claim an object or resource, annotating a digital document, generating an audio signal, or determining a network resource to use in a telecommunication operation.

Each action 120 is evaluated against the control layer 112 (e.g., against the constraints 116, role 114, and/or other control parameters 118) to check that the action 120 satisfies the relevant constraints 116. If the action 120 satisfies the constraints 116 and/or other parameters of the control layer 112, then computer system 100 proceeds to block 106 and permits the agent 110 to perform the action 120.

In response to determining that the action 120 does not satisfy the constraints 116 and/or the other control parameters 118, computer system 100 proceeds to block 108 to change or block the action 120. For example, computer system 100 may change the action 120 to refer to a different database or memory location that is permitted by constraints 116, or completely block the agent 110 from performing the action 120.

In some embodiments, computer system 100 may signal to the agent 110 to discontinue the action 120, or prevent an outbound signal from agent 110 from reaching its intended destination. The mechanism for blocking or changing action 120 may vary, depending on the task 102, the agent 110, and/or the action 120.

The computer system 100 works to ensure that every agent operates within a clearly defined role and set of constraints. This supports dynamic, context-aware task assignment and execution that aligns with efficient memory management and access, cybersecurity concerns, and other data policies. By evaluating and enforcing constraints in real time, blocking or modifying actions that do not comply, the system restricts the agent's actions in a controlled manner.

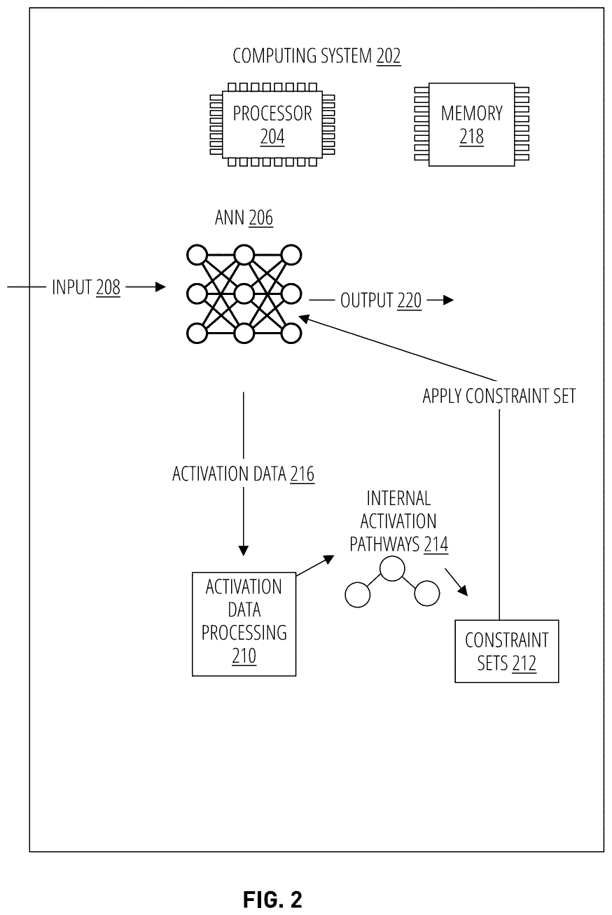

FIG. 2 illustrates a computing system configured to perform runtime control of internal activation pathways within an artificial neural network during inferencing, in accordance with some embodiments. In some embodiments, the control of the described artificial neural network 206 and mechanisms for this control may be integral within an AI agent, such as those AI agents described with respect to FIG. 1 or other sections.

Generally, the computing system 202 receives activation data 216 comprising intermediate numerical representations produced by internal layers of the artificial neural network 206 as the artificial neural network 206 processes an input 208. The computing system 202 determines one or more internal activation pathways 214, each corresponding to a distinguishable computational trajectory through those internal layers, evaluates the activation data 216 against the constraint set 212 corresponding to each respective internal activation pathway 214, and generates a controlled output 220 of the artificial neural network 206. In such a manner, the computing system 202 alters the output 220 of the artificial neural network 206 based on the constraint sets 212 by using the parameters of the constraint sets 212 to influence the inferencing behavior of the artificial neural network 206 and the resulting output 220.

The computing system 202 may include one or more processors 204 and a memory 218 storing instructions that, when executed by the one or more processors 204, may configure the computing system 202 to perform these operations during each inference pass of the artificial neural network 206 without modifying the stored parameters of the artificial neural network 206. The memory 218 may include random access memory (RAM), cache memory, or other suitable runtime memory. The memory 218 may be used to store data, instructions, and algorithms, such as the artificial neural network 206.

An artificial neural network 206 can be a parameterized computational model composed of artificial neurons (nodes) arranged in multiple layers, such as input layers, one or more hidden layers, and output layers. Each neuron can receive inputs from neurons in a preceding layer, compute a weighted combination of those inputs, and apply a nonlinear activation function, enabling the network to represent complex, non-linear mappings from input data to output data. Network architectures can include feedforward networks, convolutional neural networks that can process spatially structured data, recurrent networks such as LSTMs and GRUs that can model temporal or sequential relationships, transformer architectures that can rely on attention mechanisms to capture long-range dependencies, graph neural networks that can operate on relational graph data, and autoencoder-based models that can learn latent representations. Large language models can be implemented using transformer-based neural network architectures trained at scale to model and generate natural language.

Training an artificial neural network can involve iteratively performing forward passes through the layered structure to produce outputs, computing a loss relative to target data, propagating gradients backward through the layers using backpropagation, and updating parameters using optimization algorithms such as stochastic gradient descent or other algorithm. After training, inference can be performed by fixing the learned parameters and executing forward passes to generate predictions, classifications, embeddings, or generated content, often under constraints related to latency, power consumption, or deployment hardware. Generally, the artificial neural network 206 can be applied to a variety of applications such as, for example, computer vision, natural language processing, speech recognition, cybersecurity anomaly detection, autonomous systems, healthcare diagnostics, financial modeling, and industrial monitoring.

The artificial neural network 206 may be implemented as a transformer model, a sparse transformer model, a mixture-of-experts (MoE) model, an autoencoder-augmented model, or other suitable artificial neural network architecture. The artificial neural network 206 may receive an input 208 for processing during inference. The input 208 may comprise, for example, a token stream, a sequence of embeddings, a multimodal input, or any other data representation suitable for processing by the artificial neural network 206. During inference, the artificial neural network 206 may process the input 208 through its internal layers (which may include, for example, attention layers, feedforward layers, expert routing layers, normalization layers, or other computational stages) and produce intermediate numerical representations at each stage of the forward pass. Each internal layer may produce a corresponding set of intermediate numerical representations as the input 208 propagates through the artificial neural network 206. These intermediate numerical representations may constitute activation data 216, which may be received and processed by an activation data processing block 210. Each input 208 may cause activation of different nodes in different layers, resulting in a potentially unique path of nodes and activations.

In some embodiments, the computing system 202 and described internal pathway governance mechanisms may be model-agnostic. The system 202 can include or interface with a variety of artificial neural network architectures without departing from the scope of the present disclosure. The system may receive activation data 216 through any suitable interpretability interface, including sparse autoencoder (SAE) outputs, mixture-of-experts (MoE) routing signals, transformer attention maps, or other interpretability APIs that expose intermediate representations during inference. In embodiments where such interpretability signals are unavailable or incomplete, the computing system 202 may implement fallback behavior, such as, for example, operating with reduced granularity by evaluating activation data at the layer level rather than the feature level, applying default constraint sets that enforce general safety bounds without pathway-specific modulation, or logging activation patterns for subsequent offline analysis while permitting the inference to complete.

The activation data 216 may comprise the numerical outputs produced by neurons, layers, subnetworks, or routing mechanisms within the artificial neural network 206 as the input 208 propagates through the model's internal layers during inference. The activation data 216 may include activation magnitudes, which may indicate the strength at which particular neurons or features fire during the forward pass. The activation data 216 may also include activation timing, which may indicate when particular neurons or features fire relative to the forward pass. The activation data 216 may further include activation vectors, which may represent directional states in high-dimensional representation space and may encode semantic or functional information about the computation being performed. The activation data 216 may further include co-activation patterns, which may reflect which neurons or features fire together in response to the input 208. In embodiments employing an MoE architecture, the activation data 216 may include expert-routing signals, which may indicate which expert modules are selected by a gating function during the forward pass. Additionally, or alternatively, the activation data 216 may include feature-usage patterns, which may track activation distributions across layers and may indicate how different internal features contribute at various depths within the artificial neural network 206.

At activation data processing block 210, the computing system 202 determines, based on the received activation data 216, one or more internal activation pathways 214 within the artificial neural network 206. An internal activation pathway 214 may represent a computational trajectory through one or more internal layers of the artificial neural network 206 that contributes to the output of the model. An internal activation pathway 214 is more than a simple trace of a single node at each layer. Rather, an internal activation pathway 214 may be understood as a distributed activation fingerprint that comprises a characteristic pattern of activations spanning multiple nodes and connections across one or more layers of the artificial neural network 206 which, taken together, corresponds to a recognizable inferencing behavior of the model.

In some embodiments, an internal activation pathway 214 may comprise one or more activation subgraphs, which may represent identifiable subsets of nodes and connections across one or more layers of the artificial neural network 206. Each activation subgraph may correspond to an observed inference behavior of the artificial neural network 206. Observed inference behaviors may include, for example, factual retrieval, multi-step reasoning, coherence checking, numerical processing, or creative generation, among others. The correspondence between an activation subgraph and an observed inference behavior may be established through prior analysis of the artificial neural network 206, through runtime observation, or through a combination of both.

Internal activation pathways 214 may be identified with different characteristics and behaviors depending on architecture type of the artificial neural network 206, and multiple internal activation pathways 214 may be determined as active for a single inference based on activation data 216 for that inference. For example, in a transformer-based implementation of the artificial neural network 206, one internal activation pathway 214 may correspond to a factual-retrieval behavior comprising, for example, a cluster of attention heads in early-to-mid layers that attend to factual content in the input 208, together with a set of feedforward neurons in mid-to-late layers that refine and propagate the retrieved factual information toward the output. A second internal activation pathway 214, active during the same inference pass, may correspond to a coherence-checking behavior, comprising a different sparse circuit spanning later layers of the artificial neural network 206 that evaluates whether the emerging output is logically consistent. A third internal activation pathway 214 may correspond to a creative-generation behavior, comprising a distinct set of attention patterns and feedforward activations that drive open-ended or generative output. In MoE-based implementations, an internal activation pathway 214 may correspond to the combination of expert modules selected by the routing mechanism at each layer, for example, expert 3 at layer 4, expert 7 at layer 12, and expert 1 at layer 20, where that particular combination of expert selections collectively implements a recognizable reasoning function.

As such, during a typical inference pass, the artificial neural network 206 may activate multiple internal activation pathways 214 simultaneously. The internal layers of the artificial neural network 206 may exhibit several recognizable activation patterns at once, each corresponding to a different internal activation pathway 214 and each contributing to the output in an identifiable way. For example, the artificial neural network 206 may simultaneously activate a factual-retrieval pathway, a coherence-checking pathway, and a creative-generation pathway in response to a single input 208. Each of these concurrently active pathways may have its own corresponding constraint set 212, and the activation data processing block 210 may evaluate, modulate, and arbitrate among all active pathways during the same inference pass. The co-activation rules within the constraint sets 212, which define which pathways may or may not be active simultaneously and at what relative magnitudes, may be used to control inferencing when multiple pathways are active at the same time. Computing system 202 may perform arbitration (as described further in other sections) to resolve how the contributions of these multiple concurrent pathways are combined, weighted, or selectively excluded to produce the output 220 of the artificial neural network 206.

At activation data processing block 210, the computing system 202 may identify one or more internal activation pathways 214 using one or more suitable identification techniques. These techniques may include explicit tracing, in which the computing system 202 directly follows the flow of activation signals through a subset of nodes and connections across layers; statistical inference, in which the computing system 202 infers pathway identity from probabilistic patterns observed in the activation data 216 across multiple inputs or inference steps; pattern matching, in which observed activation data 216 is compared against stored activation signatures or templates to identify a known pathway; attribution methods, in which gradient-based or other attribution techniques associate activation patterns with corresponding computational functions; and subgraph detection, in which activation clusters or routing decisions are analyzed to identify a governed computational route. For example, the activation data processing block 210 may pass the activation data 216 through a sparse autoencoder, which is a secondary neural network trained to decompose complex activation patterns into individual, interpretable features, where each extracted feature may correspond to a single identifiable concept or function within the artificial neural network 206. Alternatively or additionally, the activation data processing block 210 may group activations that consistently fire together or exhibit similar patterns across inputs into clusters, using similarity measures such as cosine similarity, mutual information, or functional correlation, where each resulting cluster may represent a distinct internal activation pathway 214. In an embodiment, the computing system 202 may refer to a pre-built dictionary of known activation signatures (e.g., a stored catalog of previously observed activation patterns and their corresponding pathway identifications) to match incoming activation data 216 against known pathways. When the artificial neural network 206 comprises a MoE architecture, the computing system 202 may identify internal activation pathways 214 by analyzing which expert modules are selected by the model's routing mechanism during the forward pass, where each selected expert or combination of experts may constitute a distinct pathway. The computing system 202 may further identify pathways by observing which activation patterns produce consistent effects on the model's output across different inputs and tasks, thereby associating those patterns with stable functional roles within the artificial neural network 206.

In some embodiments, the computing system 202 may maintain a registry that associates each known internal activation pathway 214 with a unique identifier. The registry may serve as a catalog of previously observed and characterized pathways, enabling the computing system 202 to efficiently look up and reference known pathways during inferencing. To determine an internal activation pathway 214, the computing system 202 may reference the registry based on the received activation data 216 to identify which cataloged pathway or pathways may correspond to the observed activations, pathway tracing, and/or other techniques described in other sections.

In some embodiments, the one or more internal activation pathways 214 may not correspond to any pre-existing entry in the registry. The one or more internal activation pathways 214 may be a dynamically determined subgraph, indicated by activation data 216 that forms during inference in response to the particular input 208 being processed. Such emergent pathways may arise from a variety of sources. For example, attention gating patterns may produce new activation topologies not previously cataloged. Conditional activation clusters may form when particular combinations of features activate together for the first time in response to a particular input. Token-dependent subgraph formations may emerge when a particular set of tokens in the input 208 trigger a unique pattern of activations across layers. New combinations of expert routing decisions in MoE architectures may also give rise to emergent pathways that have not been previously observed. In these cases of newly identified pathways, the computing system 202 may, at activation data processing block 210, dynamically generate a new constraint set 212 for the emergent pathway based on the activation data 216 observed during the inference. The computing system 202 may dynamically generate the constraint set 212 from a variety of data points. For example, the computing system 202 may generate the constraint set 212 from observed activation magnitudes and patterns of the emergent pathway, domain alignment analysis, similarity to known pathways in the registry, or a combination thereof.

Each internal activation pathway 214, whether previously registered or dynamically identified, may correspond to a constraint set 212 that is also previously determined or dynamically identified. That constraint set 212 defines permissible activation behavior for that internal activation pathway 214. The constraint sets 212 operate at a computational level, not merely as semantic or policy-level rules applied only to outputs, and may comprise quantitative controls such as numeric bounds, activation thresholds, masks, gating coefficients, sparsity targets, and scaling functions. The constraint set 212 may comprise one or more rules, conditions, and thresholds that specify the boundaries within which the internal activation pathway 214 may be permitted to operate. Additionally, or alternatively, the constraint set 212 may include permitted activation magnitude ranges, which may specify upper and lower bounds for activation values associated with the pathway. The constraint set 212 may also include co-activation rules, which may define which pathways may or may not be active simultaneously and at what relative magnitudes. The constraint set 212 may further include domain-alignment criteria, which may restrict a pathway to functional contexts such as retrieval-driven contexts or analytical contexts. Additionally, the constraint set 212 may include layer-specific limits, which may constrain activation behavior at particular depths within the artificial neural network 206. The constraint set 212 may also include prohibited activations, which may specify conditions under which a pathway must not fire or must be suppressed.

In some embodiments, the constraint set 212 may be organized as a hierarchical constraint stack comprising multiple tiers of constraints that may be enforced in a defined order. The hierarchical constraint stack may include a primary constraint tier, which may define safety bounds, hard domain limits, and mandatory activation thresholds. These primary constraints may represent the highest-priority rules and may be enforced first. The hierarchical constraint stack may further include a secondary constraint tier, which may define coherence scoring requirements, logical consistency requirements, and dependency rules governing relationships between pathways. These secondary constraints may be enforced after the primary constraints have been evaluated. The hierarchical constraint stack may further include a tertiary constraint tier, which may define optional behavioral refinements and optional structural constraints. These tertiary constraints may represent the most fine-grained rules and may be enforced after both primary and secondary constraints have been evaluated. During evaluation, the primary, secondary, and tertiary constraints may be enforced in hierarchical order. A composite violation score may be generated reflecting the aggregate degree of constraint deviation across all tiers. The composite violation score may weight violations at higher tiers more heavily than violations at lower tiers.

In some embodiments, the constraint set 212 may include latent-level conflict resolution mechanisms that define how the computing system 202 is to respond when an internal activation pathway 214 violates its constraints. These conflict resolution mechanisms may include: suppression, in which the pathway's activation may be reduced to zero or below a defined threshold; scaling, in which the pathway's activation may be multiplied by a correction factor proportional to the violation severity; rerouting, in which the pathway's activation contribution may be redirected to an alternative pathway with compatible constraints; and/or replacement, in which the pathway's activation may be substituted with the activation of a predefined fallback pathway that serves a similar functional role. The constraint set 212 may specify which resolution mechanism or combination of mechanisms is to be applied for different categories of violations. Additionally, or alternatively, the constraint set 212 may define precedence rules that govern the order in which constraints are evaluated and enforced.

The constraint set 212 may be sourced from one or more origins. For example, the constraint set 212 may be loaded from a predefined library of constraint definitions. Alternatively, the constraint set 212 may be dynamically generated based on observed activation behavior and domain alignment analysis. In some embodiments, the constraint set 212 may be provided via operator-supplied configuration, enabling a system administrator or deployment operator to specify rules tailored to a particular use case. In some embodiments, the constraint set 212 may include evolution rules that adjust constraints based on historical activation patterns and recurring violation records. These evolution rules enable the computing system 202 to adapt generation and enforcement of the constraints, thus adapting the behavioral output of a given internal activation pathway 214 of an artificial neural network 206 over time, as new activation patterns are observed and as the system accumulates a record of past violations and their outcomes.

The computing system 202 continues to perform the inferencing, and evaluates the activation data 216 against the constraint set 212 corresponding to each determined internal activation pathway 214. In some embodiments, this evaluation occurs iteratively during inference, including on a per-token or step-wise basis, such that constraint evaluation and any resulting modulation may be applied at each individual generation step rather than only as a single pass over the complete input or output. The evaluation may determine whether the activation data 216 satisfies the constraint set 212. The evaluation may assess whether the observed activation magnitudes fall within the permissible ranges defined by the constraint set 212. The evaluation may further assess whether co-activation patterns conform to the co-activation rules specified in the constraint set 212. The evaluation may also assess whether domain alignment of the activation data 216 meets the domain-alignment criteria defined in the constraint set 212. Other measurable properties of the activation data 216 may also be evaluated against their corresponding constraints. A violation signal may be generated when any constraint within the constraint set 212 is breached. A violation score may also be computed, reflecting the severity or degree of deviation from the permissible boundaries. The violation score may be used to inform the type and magnitude of any subsequent modulation action.

Where a plurality of internal activation pathways 214 are active simultaneously for a given inference, each pathway may be evaluated independently against its corresponding constraint set 212. If the activation data 216 of a given internal activation pathway 214 satisfies its corresponding constraint set 212, that pathway may be passed forward to the output 220 without modification. In such a case, the constraint set 212 impose no effect on that pathway's contribution. Only those internal activation pathways 214 whose activation data 216 does not satisfy the corresponding constraint set 212 are subject to modulation. For example, where a first of the internal activation pathways 214 satisfies its constraint set 212 but a second of the internal activation pathways 214 does not, the computing system 202 applies the constraint set 212 corresponding to the second internal activation pathway 214 to modulate its activation data 216, while permitting the activation data 216 of the first internal activation pathway 214 to proceed to the output 220 unmodified.

In response to determining that the activation data 216 of an internal activation pathway 214 does not satisfy its assigned constraint sets 212, the activation data processing block 210 may modulate the activation data 216 of the internal activation pathways 214 to bring it into compliance. Modulation may take one or more of several forms, depending on the nature and severity of the violation.

In such a manner, the computing system 202 may modify and control behavior of the artificial neural network 206 using a pathway-specific control. The computing system 202 applies the input 208 to the artificial neural network 206 and, through the activation of internal layers of the artificial neural network 206, the computing system 202 collects the activation data 216 produced at each layer, determines one or more internal activation pathways 214 based on the collected activation data 216, and obtains the constraint set 212 corresponding to each determined internal activation pathways 214. Computing system 202 applies the constraint set or sets 212 to the artificial neural network 206 by evaluating the activation data 216 against the constraint set or sets 212. The computing system 202 modulates the activation of the artificial neural network 206 that does not satisfy the constraint set or sets 212, to guide the artificial neural network 206 to generate the output 220 based on the constraint-compliant activation data within the artificial neural network 206. As described, the application of the artificial neural network 206 may vary, and as such, the system may respond to the output with a variety of actions. For example, the output can be used to block or filter data, turn machinery or computer systems on or off, drive displayed outputs, control an actuator, transmit an alert, etc.

In some embodiments, the modulation of the artificial neural network 206 may comprise suppression. Computing system 202 may reduce the activation value between nodes of one or more layers to zero or below a defined threshold, which may effectively silence the contribution of a given internal activation pathway 214 to the forward pass. Computing system 202 may perform suppression when the violation is severe (e.g., based on a threshold) and/or when the pathway's activation behavior poses a safety risk as determined by the primary constraints.

In some embodiments, the modulation may comprise scaling. Scaling may multiply the activation tensor by a correction factor that may be proportional to the violation score. Scaling may reduce the pathway's influence on the output without fully silencing it, and may be appropriate when the violation is moderate and the pathway's contribution remains partially useful.

In some embodiments, the modulation may comprise redirection. Redirection may reroute the activation contribution away from the violating pathway and toward an alternative pathway that may be selected based on constraint compatibility. The alternative pathway may be identified by the computing system 202 based on domain alignment, constraint satisfaction, or functional similarity to the violating pathway.

In some embodiments, the modulation may comprise fallback substitution. The computing system 202 may apply fallback substitution to replace a violating pathway's activation with the activation of a predefined or algorithmically selected fallback pathway. The fallback pathway may be a pathway that fills the same or a similar functional role as the violating pathway but operates within safe boundaries as defined by its own constraint sets 212. The fallback pathway may be included in the constraint sets 212.

In some embodiments, the modulation may comprise micro-constraint injection, as described further in other sections. Micro-constraint injection may apply a temporary constraint override with a defined time-to-live (TTL). The TTL may specify a number of inference steps for which the temporary constraint remains active. During the TTL period, the temporary constraint may restrict the pathway's activation behavior more tightly than the pathway's baseline constraint sets 212. After the TTL expires, the temporary constraint may be automatically removed and the pathway may return to behavior under its baseline constraint sets 212.

Generally, all modulation actions may be performed by computing system 202 without modifying the stored parameters of the artificial neural network 206. The model's trained weights may remain unchanged throughout the process, from one inference to another. Latent pathway activation is ephemeral and scoped to the task context of the current inference: the modulation operates solely on the activation data 216 flowing through the model during the current inference pass, and the system returns to baseline activation permissibility after the inference is complete or after TTL expiration. This leaves the artificial neural network 206 in its original trained state after inference is complete, thereby maintaining a consistent baseline behavior of the artificial neural network 206 while also reducing the amount of training and retraining of models to control or modify the behavior of that model.

As described, where a plurality of internal activation pathways 214 may be active simultaneously within the artificial neural network 206, the activation data processing block 210 may perform arbitration among the plurality of pathways. Arbitration may determine which pathways will contribute to the model's final output and to what degree each contributing pathway may influence the output. The computing system 202 may perform arbitration with a variety of approaches. In some embodiments, arbitration may employ constraint-coherence weighting, in which the contribution of each internal activation pathways 214 may be weighted based on how well or closely the activation data 216 satisfies its respective constraint set 212. Pathways that satisfy their constraint sets more may receive higher weights and thus contribute more heavily to the output 220.

In some embodiments, arbitration may employ selection or exclusion based on violation severity. Pathways with high-severity constraint violations may be excluded from contributing to the output entirely, while pathways with low-severity or no violations may be permitted to contribute. In some embodiments, arbitration may employ weighted voting among pathways. Each active pathway may cast a weighted vote based on its constraint satisfaction score, and the output may be composed based on the aggregated vote results. In some embodiments, arbitration may employ priority scoring based on domain classification. Pathways that are more closely aligned with the domain of the input 208 may receive higher priority in determining the final output. In some embodiments, arbitration may employ domain veto logic, under which a pathway whose domain classification does not match the domain of the current input is categorically excluded from contributing to the output regardless of its constraint satisfaction score, enforcing strict domain boundaries at the arbitration stage.

In some embodiments, the arbitration mechanism may invoke advanced conflict resolution mechanisms when latent pathways converge on conflicting outputs or when arbitration fails to produce a clear resolution. These advanced mechanisms may include deadlock detection, in which the computing system 202 identifies when multiple pathways have reached a state where no pathway can progress without violating its constraint set, triggering an escalation procedure. The mechanisms may also include counter-constraint injection, in which temporary constraints are introduced to break a deadlock by selectively relaxing or tightening specific pathway constraints until a viable resolution emerges. Divergence expansion may be employed, in which the computing system 202 explores multiple candidate outputs in parallel by temporarily permitting each conflicting pathway to generate its contribution independently, then comparing and selecting among the divergent results based on composite constraint satisfaction scores. Recursive arbitration may be applied, in which the arbitration process is re-applied (e.g., in one or more additional arbitration rounds) to the outputs of an initial arbitration round, enabling multi-level resolution of complex conflicts.

In some embodiments, as described further in other sections, stored context accessed by the artificial neural network 206 during inference may be partitioned into a plurality of memory segments. The memory segments may include, for example, short-term context, which may comprise recent conversational or input history. The memory segments may also include episodic trace, which may comprise records of prior interactions or events. The memory segments may further include long-term semantic memory, which may comprise factual or conceptual knowledge persisted across sessions. The memory segments may also include procedural knowledge, which may comprise operational rules or behavioral templates. Other types of memory segments may also be used.

The activation data processing block 210 may filter the stored context provided to each internal activation pathways 214 by permitting access to only a subset of the plurality of memory segments as defined by the constraint sets 212 corresponding to that pathway. This memory segmentation may prevent a pathway from accessing stored context outside its designated scope. For example, memory segmentation may prevent a creative-generation pathway from retrieving sensitive factual data that its constraint sets 212 does not authorize. As another example, memory segmentation may restrict a retrieval pathway to short-term context only, preventing it from accessing long-term semantic memory that may not be relevant to the current input 208. Access filtering decisions may be logged as part of a stored record.

Based on the modulated and arbitrated activation data 216, the computing system 202 may generate an output of the artificial neural network 206. The output may comprise logits representing probability distributions over possible next tokens. The output may alternatively comprise intermediate representations that reflect only constraint-compliant activations and may be passed to subsequent processing stages. The output may also comprise a fully decoded output such as generated text, a classification decision, or an action, depending on the type and architecture of the artificial neural network 206. The output may reflect only those internal activation pathways 214 whose activation data 216 has passed constraint evaluation, been modulated into satisfying the constraints where necessary, and survived pathway arbitration. In addition to reflecting constraint-compliant activations, the output may conform to the tone profiles associated with the contributing pathways, such that the behavioral tone of the output for example, its degree of assertiveness, neutrality, or domain-specific register-is governed by the tone vectors embedded in the role definitions of the active pathways that contributed to the final output.

The computing system 202 may further generate and store a computer log for each inference pass. The log may comprise an identification of each internal activation pathway 214 that was active during the inference. The log may also comprise the result of evaluating each pathway's activation data 216 against its corresponding constraint set 212, including any violation signals and violation scores that were generated. The log may further comprise a description of any modulation actions that were applied to the activation data 216, including the type of modulation, the magnitude of any correction factors, and whether any TTL-based micro-constraints were injected. The log may also comprise arbitration outcomes, including which pathways were selected, weighted, or excluded from contributing to the final output, and the basis for those arbitration decisions. The log may further comprise any memory access filtering that was performed, including which memory segments were permitted or denied for each pathway. The log may be stored in a structured format suitable for auditing, interpretability, debugging, or regulatory compliance purposes. In some embodiments, the log may be rendered into a human-interpretable explanation of the path-based actions taken during the inference.

As an example of how the computing system 202 can produce different controlled outputs 220 from the same artificial neural network 206 without modifying its stored parameters, consider two inference passes. Each internal activation pathway 310, as a discrete, identifiable computational trajectory that emerges from the ANN's internal layers, may be understood as a latent unit which is a bounded functional structure that is latent within the trained model that becomes active during inference. Together, a latent unit, its associated role definition 312 (specifying the functional responsibility and behavioral tone profile of the pathway), and its corresponding constraint set 212 (defining permissible activation behavior) constitute what may be referred to as a Latent Role and Constraints (LRC). The LRC characterizes the activation pathway's computational identity as well as the behavioral boundaries and role-based rules under which it is permitted to operate. When the computing system 202 applies a first input 208, the activation data processing block 210 determines a first of the internal activation pathways 214 (for example, a factual-retrieval pathway and a coherence-checking pathway) and applies their corresponding constraint sets 212 (the constraint component of each LRC) to govern and produce a first of the output 220. When the computing system 202 applies a second input 208 (e.g., at a second time after performing the first inference) to the same artificial neural network 206, the different input 208 causes the system at activation data processing block 210 to determine a second one or more internal activation pathways 214 (for example, a multi-step reasoning pathway and a creative-generation pathway) with their own constraint sets 212, resulting in a second output 220 that differs from the first, not only because the inputs are different, but also because the LRCs applied are different. The stored parameters of the artificial neural network 206 (e.g., those that are trained) may be identical across both inferences.

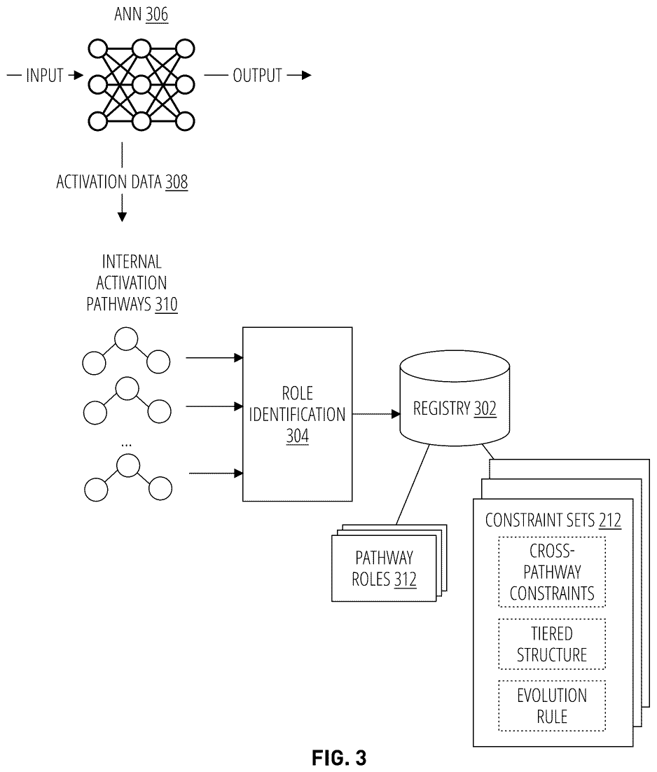

FIG. 3 shows an example workflow for determining and storing internal activation pathways, in accordance with some embodiments. The workflow may be performed by a computing system described in other sections, such as, for example, computing system 202. FIG. 3 illustrates how internal activation pathways may be identified and associated with roles and constraint sets for those pathways.

An ANN 306 may be the same artificial neural network described in connection with other figures, such as artificial neural network 206. The ANN 306 may be implemented as a transformer model, a sparse transformer model, a mixture-of-experts (MoE) model, an autoencoder-augmented model, or other suitable neural network architecture. During operation, the ANN 306 produces activation data 308 as it processes inputs through its internal layers. The activation data 308 may comprise intermediate numerical representations produced by neurons, layers, subnetworks, or routing mechanisms within the ANN 306, including activation magnitudes, activation vectors, co-activation patterns, expert-routing signals, and feature-usage patterns across layers.

The activation data 308 may be analyzed by a computing system at role identification block 304. At role identification block 304, the system may analyze the activation data 308 to identify one or more internal activation pathways 310 within the ANN 306. An internal activation pathway 310 may represent a distributed activation fingerprint, that is, a characteristic pattern of activations spanning multiple nodes and connections across one or more layers of the ANN 306 that corresponds to a recognizable inference behavior of the model.

The system may identify internal activation pathways 310 using one or more suitable techniques. For example, the system may pass the activation data 308 through a sparse autoencoder, which is a secondary neural network trained to decompose complex activation patterns into individual, interpretable features. Each extracted feature may correspond to a single identifiable concept or function within the ANN 306. The system may alternatively or additionally group activations that consistently fire together or exhibit similar patterns across inputs into clusters, using similarity measures such as cosine similarity, mutual information, or functional correlation. In some embodiments, the system may reference a pre-built dictionary of known activation signatures to match incoming activation data 308 against known pathways. In MoE-based implementations, the computer system may identify internal activation pathways 310 by analyzing which expert modules are selected by the model's routing mechanism during the forward pass, where each selected expert or combination of experts may constitute a distinct pathway. The system may further identify internal activation pathways 310 by observing which activation patterns produce consistent effects on the model's output across different inputs and tasks, thereby associating those patterns with stable functional roles within the ANN 306.

For each identified internal activation pathway 310, the system may determine an observed inference behavior corresponding to that pathway, such as factual retrieval, multi-step reasoning, coherence checking, numerical processing, or creative generation. This correspondence may be established through offline analysis of the ANN 306, through runtime observation, or through a combination of both. For example, at role identification block 304, the system may run characterization inputs through the ANN 306 and correlate the resulting activation patterns with known output behaviors to build a mapping of pathways to inference behaviors. Alternatively, the system may receive pathway-to-behavior mappings from an external interpretability tool, an operator-supplied configuration, or a previously generated analysis.

Once an internal activation pathway 310 has been identified and its observed inference behavior determined, the system may generate a role definition 312 for that pathway. Together, the identified internal activation pathway 310, its observed inference behavior, and its associated role definition 312 and constraint set 212 (an LRC) are determined. A role definition may correspond to a constraint set 212 specifying the permissible activation behavior for the pathway. The constraint set 212 may individual pathway constraints and cross-pathway constraints.

Individual pathway constraints may control the behavior of a single internal activation pathway 310 in isolation. These may include permitted activation magnitude ranges, domain-alignment criteria restricting the pathway to functional contexts, layer-specific limits constraining activation behavior at particular depths within the ANN 306, and prohibited activations specifying conditions under which the pathway must not fire.

Cross-pathway constraints may control the behavior of one internal activation pathway 310 relative to one or more other internal activation pathways 310. These cross-pathway constraints may include co-activation rules that define which pathways may or may not be active simultaneously and at what relative magnitudes. For example, a co-activation rule may specify that a factual-retrieval pathway may not activate above a given threshold when a creative-generation pathway is concurrently active above its own threshold. Cross-pathway constraints may also include dependency rules that specify when a pathway's activation is permitted only in combination with one or more other pathways. For example, a dependency rule may require that a coherence-checking pathway must be active whenever a multi-step reasoning pathway is active. Because cross-pathway constraints are relational, they may be stored as part of the constraint set 212 for each pathway involved, or they may be stored separately in the registry 302 as relational constraint entries that reference the unique identifiers of the involved pathways.

The role definition 312 of a pathway may also include a domain classification indicating the functional responsibility of the pathway, such as safety, factual, analytical, or creative. The role definition may further include evolution rules specifying how the constraint set 212 is to be adjusted over time based on historical activation patterns, recurring violation records, or changes in the pathway's observed behavior.

In some embodiments, latent roles assigned to internal activation pathways may inherit from a domain taxonomy that classifies pathways according to their functional responsibilities. The domain taxonomy may include categories such as safety, which may include harm detection and rule enforcement functions; factual, which may include retrieval-aligned and precision-weighted reasoning functions; analytical, which may include multi-step reasoning and logical consistency functions; and creative, which may include generative expansion and high-entropy functions, among others. Each latent role may inherit behavioral expectations and default constraint bounds from its domain classification. Latent roles may participate in hierarchical constraint stacks in which primary constraints take precedence over secondary constraints, and secondary constraints take precedence over tertiary constraints. The hierarchical structure may support behaviors for latent pathways including suppression of pathways that violate primary safety constraints, escalation of constraint evaluations to higher-tier rules when lower-tier evaluations are inconclusive. The hierarchical structure may also include a hybrid structure in which multiple pathways with complementary domain classifications contribute jointly to the output under coordinated constraint rules.

The role definition 312 of a pathway may also include a tone vector. A tone vector is a set of parameters that specifies the desired behavioral tone profile for the pathway during inference (for example, whether the pathway should contribute to output that is assertive, neutral, restrained, or aligned with a particular domain-specific register). During inference, the system evaluates whether the pathway's active behavior conforms to its assigned tone vector, and treats a detected tone drift (where the pathway's behavioral contribution deviates from its specified tone profile) as a violation that may trigger the same corrective modulation mechanisms applied to magnitude or domain violations.

The constraint set 212 may be organized as a hierarchical constraint stack comprising multiple tiers. A primary constraint tier may define safety bounds, hard domain limits, and mandatory activation thresholds. A secondary constraint tier may define coherence scoring requirements, logical consistency requirements, and dependency rules. Coherence scoring may refer to a quantitative measure of the degree to which an internal activation pathway's output is internally consistent and free of conflicting or contradictory activation signals. Logical consistency may refer to a requirement that the activation pathway's contribution does not produce outputs that contradict established facts, prior outputs within the same inference, or domain-specific rules applicable to the current input. Tone alignment may refer to a requirement that the activation pathway's behavioral contribution conforms to an assigned tone profile, such as a specified degree of assertiveness, neutrality, or domain-specific register, as defined by the pathway's role definition or a configuration (e.g., a tone setting) of the artificial neural network. A tertiary constraint tier may define optional behavioral refinements and structural constraints. The hierarchical structure may ensure that higher-priority constraints, such as safety bounds, are enforced before lower-tier refinements. Both individual pathway constraints and cross-pathway constraints may appear at any tier within the hierarchical stack.

The constraint set 212 may be sourced from one or more origins. In some embodiments, at role identification block 304, the system may load constraint sets from a predefined library containing standard constraint templates for common pathway types. In other embodiments, the system may auto-generate constraint sets based on the observed activation behavior of the identified pathway. For example, if a particular internal activation pathway 310 corresponds to a factual-retrieval behavior, the system may generate a constraint set 212 that includes tight activation magnitude bounds, strict domain-alignment criteria, and co-activation rules limiting concurrent activation with creative-generation pathways. In still other embodiments, the system may receive constraint sets from an operator-supplied configuration, enabling a system administrator to specify rules tailored to a particular use case.

The identified internal activation pathways 310, together with their associated role definitions 312 and constraint sets 212, may be stored in a registry 302. The registry 302 may associate each known internal activation pathway 310 with a unique identifier (e.g., a name and/or number), its role definition 312, its constraint set 212, its domain classification, any cross-pathway constraint references, and any evolution rules.

In some embodiments, the registry 302 may be configured to persist role mappings and constraint sets across sessions, enabling reuse of validated latent configurations. The registry 302 may store performance metrics for each registered internal activation pathway 310, including historical activation frequencies, constraint satisfaction rates, violation counts, and average modulation actions applied. The registry 302 may further track which internal activation pathways 310 have been validated through prior operation as producing constraint-compliant outputs, enabling the computing system to preferentially rely on these validated pathways when processing similar inputs.

During inference, the computing system may use the registry 302 to match observed activation data against known internal activation pathways 310 and retrieve corresponding constraint sets 212. As the ANN 306 processes an input and produces activation data, the computing system may compare the observed activation patterns against the activation signatures stored in the registry 302. When the observed activation data sufficiently corresponds to a registered internal activation pathway 310, for example by exceeding a similarity threshold against the pathway's stored activation signature, the computing system may retrieve the pathway's unique identifier, its constraint set 212, and any associated cross-pathway constraints. The retrieved constraint set 212 may then be used to evaluate and control the pathway's activation behavior during the forward pass.

Where multiple internal activation pathways 310 are identified during a single inference pass, the computing system may retrieve the constraint sets 212 for each active pathway and any cross-pathway constraints that affect their relationships. For example, if the registry 302 indicates that two pathways are subject to a co-activation rule limiting their concurrent activation magnitudes, the computing system may retrieve and enforce that relational constraint alongside each pathway's individual constraints.

The registry 302 may be updated over time as the role identification block 304 identifies new internal activation pathways 310 or refines existing role definitions. For example, if the ANN 306 is updated or if new inputs reveal previously unobserved activation patterns, the role identification block 304 may identify new pathways and add corresponding role definitions to the registry 302. Similarly, if evolution rules indicate that a constraint set 212 should be adjusted based on accumulated violation records, the registry 302 may be updated accordingly.

In some embodiments, the role identification block 304 may determine dynamically emergent pathways. These pathways may form spontaneously during inference in response to a particular input and may not correspond to any pre-existing entry in the registry 302. In these cases, the role identification block 304 may dynamically generate a new role definition and constraint set 212 based on the activation data 308 observed during the inference. The newly generated role definition and constraint set 212 may optionally be added to the registry 302 for use in future inference passes.

The workflow illustrated in FIG. 3 may be performed as a pre-inference setup process in which the computing system populates the registry 302 before controlled inference begins. Alternatively, the workflow may be performed continuously or periodically during operation as the computing system encounters new activation patterns. In either case, the output of the workflow, a populated registry 302 associating internal activation pathways 310 with their respective constraint sets 212, provides the foundation for the runtime control described in connection with other figures.

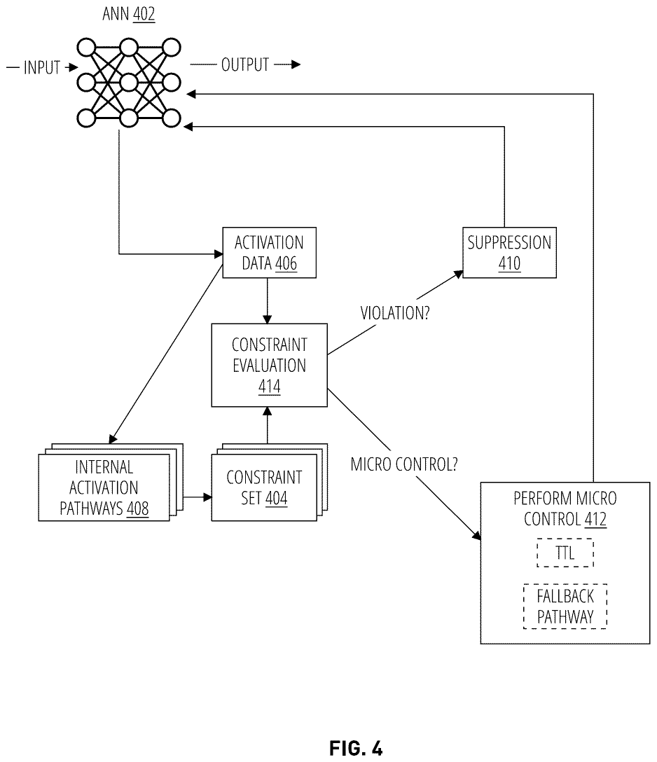

FIG. 4 shows an example workflow for evaluating activation data against a constraint set and determining a corrective action, in accordance with some embodiments. The workflow may be performed by a computing system described in other sections, such as, for example, computing system 202.

Generally, FIG. 4 illustrates how the computing system analyzes the activation data produced by an artificial neural network during inference, evaluates that activation data against a corresponding constraint set, and determines whether to apply suppression or a micro-control approach, based on the nature and severity of the detected violation.

As described, an ANN 402 may be the same artificial neural network described in connection with other figures, such as artificial neural network 206. During inference, the ANN 402 processes an input through its internal layers and produces activation data 406 comprising intermediate numerical representations at each stage of the forward pass.

The computing system may determine, based on the activation data 406, one or more internal activation pathways 408 within the ANN 402. As described in connection with other figures, each internal activation pathway 408 may represent a distributed activation fingerprint corresponding to a recognizable inference behavior of the ANN 402. Once the computing system determines an internal activation pathway 408, it may retrieve the corresponding constraint set 404 from a registry or dynamically determine the constraint set 404. The constraint set 404 defines permissible activation behavior for the internal activation pathway 408, and may include permitted activation magnitude ranges, co-activation rules, domain-alignment criteria, layer-specific limits, and prohibited activations.

At constraint evaluation block 414, the computing system analyzes the activation data 406 against the constraint set 404 corresponding to the determined internal activation pathway 408. The computing system may assess multiple dimensions of the activation data 406. The computing system may check whether the observed activation magnitudes fall within the permitted ranges defined by the constraint set 404. The computing system may check whether co-activation patterns satisfy the co-activation rules specified in the constraint set 404. The computing system may also check whether the domain alignment of the activation data 406 meets domain-alignment criteria in the constraint set 404.

In some embodiments, if at constraint evaluation block 414, the computer system determines that the activation data 406 satisfies the constraint set 404, the computing system may pass the activation data 406 forward unmodified. In this case, no corrective action is applied, and the activation data 406 continues through the forward pass to contribute to the output of the ANN 402.

If at constraint evaluation block 414, the system determines that the activation data 406 does not satisfy the constraint set 404, the computing system may detect a violation and compute a violation score reflecting the severity and nature of the deviation from the constraints. The violation score may quantify the degree to which the activation data 406 deviates from the permissible boundaries defined in the constraint set 404. The computing system may use this violation score to determine whether to proceed to suppression 410 or to perform micro-control 412.

The determination of whether to apply suppression 410 or micro-control 412 may depend on one or more conditions evaluated by the computing system at the constraint evaluation block 414. These conditions may include the severity of the violation as indicated by the violation score, a constraint tier at which the violation occurred, and/or a type of mismatch detected.

The computing system may proceed to suppression 410 when the violation score exceeds a severity threshold indicating that the pathway's activation poses an immediate risk to the output. For example, a violation of a primary constraint, such as a safety bound or a mandatory activation threshold, may indicate that the pathway's contribution should be immediately reduced or eliminated. The computing system may also proceed to suppression 410 when the activation magnitude substantially exceeds its permitted range, indicating that the pathway is contributing disproportionately to the forward pass.

At suppression 410, the computing system may apply one or more immediate corrective actions to the activation data 406. As described, the computing system may reduce the activation value to zero, effectively silencing the pathway's contribution to the forward pass entirely. Alternatively, the computing system may scale the activation tensor by a correction factor that may be computed proportionally to the violation score. For example, if the activation magnitude is 0.82 and the permitted maximum is 0.41, the computing system may multiply the activation tensor by a factor of approximately 0.5 to bring it within the permissible range. The computing system may also redirect the activation contribution away from the violating pathway and toward an alternative pathway selected based on constraint compatibility. Suppression 410 operates on the activation data 406 directly and takes effect within the current inference step.

The computing system may proceed to micro-control 412 when the violation indicates a condition that may persist across multiple inference steps and that warrants a temporary tightening of the pathway's constraints rather than an immediate correction to the activation values. For example, a domain mismatch, where the activation data 406 indicates that the pathway is operating outside its designated functional context, may warrant micro-control because the misalignment is likely to recur on subsequent inference steps if only the current activation values are corrected. Similarly, co-activation violations, where two or more pathways are interacting in ways that breach their relational constraints, may warrant micro-control to temporarily restrict the pathways' concurrent behavior over a defined window. The computing system may also proceed to micro-control 412 when the violation score falls below the severity threshold for suppression but still indicates a deviation that should be addressed proactively.

At micro-control 412, the computing system may inject a temporary constraint override into the constraint set 404 for the affected internal activation pathway 408. The temporary constraint may be more restrictive than the pathway's baseline constraint set 404, tightening the permissible activation behavior for a defined period. The computing system may assign a time-to-live (TTL) to the temporary constraint, specifying a time and/or the number of inference operations (e.g., expire after X inferences) for which the temporary constraint remains active. During the TTL period, the pathway operates under the tighter (more restrictive) control defined by the injected constraint. For example, if a domain mismatch is detected, the computing system may inject a temporary constraint that restricts the pathway's activation to a narrower domain-aligned range for the next several inference steps. As another example, if a co-activation violation is detected between two pathways, the computing system may inject a temporary constraint that reduces the permitted concurrent activation magnitudes for those pathways during the TTL period. The computing system may also select a fallback pathway to substitute for the affected pathway during the TTL period. The fallback pathway may fill the same or a similar functional role as the affected pathway but operate within safe boundaries as defined by its own constraint set. After the TTL expires, the computing system automatically removes the temporary constraint, and the pathway returns to control under its baseline constraint set 404.

In some embodiments, the computing system may apply both suppression 410 and micro-control 412 in combination. For example, the computing system may first scale the activation data 406 at suppression 410 to address the immediate violation, and then inject a temporary constraint at micro-control 412 to prevent the violation from recurring on subsequent inference steps. The combination of suppression 410 and micro-control 412 may allow the computing system to address both the immediate effect and the underlying pattern of the violation.

Following either suppression 410 or micro-control 412, a modulated version of the activation data 406 may be passed forward to contribute to the output of the ANN 402. The computing system may log the violation signal, the violation score, the corrective action taken, and any TTL parameters associated with micro-control injections as part of a record, as described in connection with other figures. Generally, corrective actions performed at suppression block 410 and micro-control block 412 may operate on and modify activation data 406 flowing through the ANN 402 during the current inference pass, without modifying the stored parameters of the ANN 402.

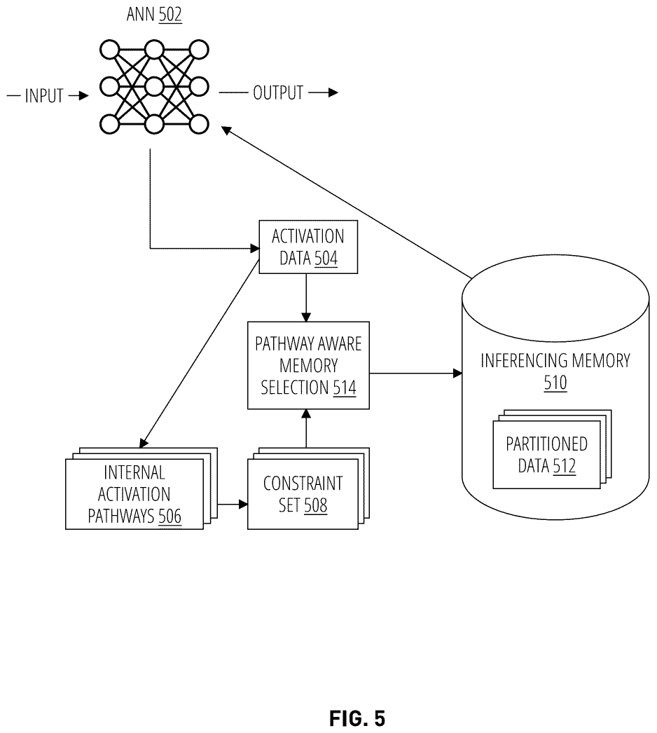

FIG. 5 illustrates memory segmentation and pathway-aware memory selection for controlling internal activation behavior of an artificial neural network during inference, in accordance with some embodiments. The operations depicted in FIG. 5 may be performed by a computer system such as the computer system described above with reference to FIG. 2.

During inference, an artificial neural network (ANN) 502 processes an input and produces activation data 504. The activation data 504 comprises intermediate numerical representations generated by one or more internal layers of the ANN 502. The computer system determines, based on the activation data 504, one or more internal activation pathways 506 within the ANN 502. Each internal activation pathway 506 corresponds to a constraint set 508 that defines permissible activation behavior for that pathway. The constraint set 508 may define, among other parameters, which portions of stored context the internal activation pathway 506 is permitted to access during inference.

The ANN 502 may access an inferencing memory 510 during inference. The inferencing memory 510 stores context that the ANN 502 may draw upon when generating an output. Depending on the application, the context data varies. Rather than providing unrestricted access to the full contents of the inferencing memory 510, the computer system organizes the inferencing memory 510 into partitioned data 512. Each partition within the partitioned data 512 may correspond to a distinct category of stored context within inferencing memory 510. For example, the partitioned data 512 may include a short-term context segment storing recent or session-scoped information, an episodic trace segment storing records of prior interactions or events, a long-term semantic segment storing persistent domain knowledge, and/or a procedural knowledge segment storing task-execution rules or operational sequences. For example, if the ANN 502 relates to analyzing and predicting weather, the context data may relate to weather data, and the partitioned data may relate to the regions of data, the different types of data (e.g., humidity, temperature, pressure, etc.), the season or length of time of the data, how far back in time the data goes, or other partitions that influence the inferencing of the ANN 502, and different constraints may restrict access to different data partitions. The partitioned data 512 is not limited to these examples and may include any number or categorization of segments which may vary according to application and deployment.

At a pathway-aware memory selection block 514, the computer system may filter which partitions of the partitioned data 512 are accessible to a given internal activation pathway 506 based on the constraint set 508 corresponding to that pathway. Each constraint set 508 may indicate which partition or partitions are accessible to the corresponding pathway. The computer system may apply a role-based memory access filter that enforces domain permissions, role-consistent memory scope, and salience threshold controls for each internal activation pathway 506. For instance, if a particular internal activation pathway 506 is associated with a constraint set 508 that restricts its function to analytical reasoning, the computer system at the pathway-aware memory selection block 514 may permit access to the long-term semantic segment and the procedural knowledge segment while restricting access to the episodic trace segment or other segments that fall outside the scope of the pathway's assigned role.

The computer system further performs constraint-aware retrieval at the pathway-aware memory selection block 514. During constraint-aware retrieval, the computer system may block or redact partitions that are forbidden under the constraint set 508. Additionally or alternatively, the system may compress or deprioritize partitions that are irrelevant or present a high risk (e.g., above a threshold) of constraint violation. The computer system may restrict access to inferencing memory 510 in accordance with the boundaries defined by the active internal activation pathway's role. The result is a restricted subset of the inferencing memory 510 for the internal activation pathway 506 currently being evaluated.

The computer system provides the restricted subset of the inferencing memory 510 back to the ANN 502 for use in the ongoing inference. In this way, the system controls the activation behavior of internal activation pathways 506 and additionally, the scope of stored context available to those pathways, which further modifies the output of the ANN 502. The output of the ANN 502 is generated based on the activation data 504 and the constraint set 508, including memory access permissions defined for the internal activation pathway 506.

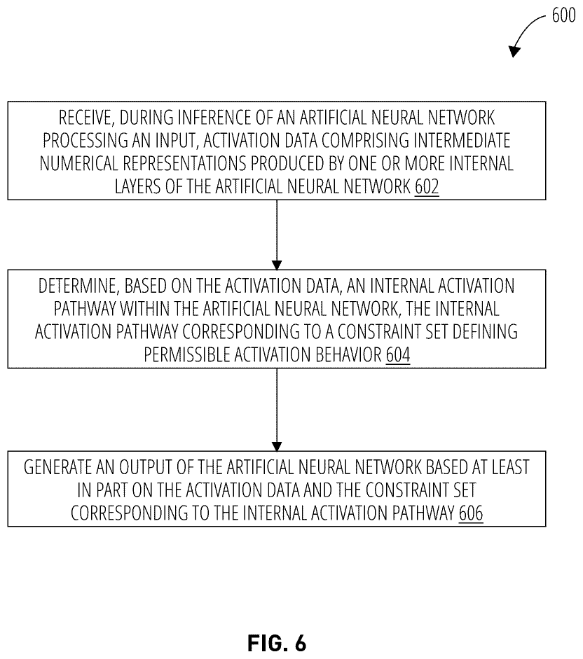

FIG. 6 shows an example method for controlling activation pathways of an artificial neural network, in accordance with some embodiments.

Method 600 may be performed by a computer system or processing logic thereof, that is configured to instantiate, deploy, and manage one or more agents, such as described in other sections. Processing logic may include an application, an operating system, a service, a subroutine, embedded instructions or a script, an agent that is governed by a control layer, or a combination thereof. It should be understood that actions described as being performed by processing logic or a computer system throughout the present disclosure, may be interpreted as being performed by the agent, or a service or routine executing separate from the agent, or a combination thereof. Method 600 may be performed by a computing device, such as those described with respect to the other figures.

At block 602, processing logic receives, during inference of an artificial neural network processing an input, activation data comprising intermediate numerical representations produced by one or more internal layers of the artificial neural network. The activation data may include activation magnitudes, activation vectors, co-activation patterns, expert-routing signals from mixture-of-experts routing mechanisms, and feature-usage patterns distributed across layers, each reflecting how the network's internal computational state evolves as the input propagates through successive layers during the forward pass. The activation data is collected continuously across layers as inference proceeds, such that the processing logic captures a runtime snapshot of the internal computational state of the artificial neural network at one or more stages of the forward pass, without interrupting or altering the propagation of signals through the network. In embodiments involving autoregressive or iterative generation, activation data may be received and processed at each individual generation step, including on a per-token basis, enabling constraint evaluation and modulation to operate continuously throughout the generation process rather than only at the beginning or end of inference.

At block 604, processing logic determines, based on the activation data, an internal activation pathway within the artificial neural network, the internal activation pathway corresponding to a constraint set defining permissible activation behavior. Determining the internal activation pathway may involve analyzing the received activation data to identify a characteristic pattern of activations spanning multiple nodes and connections across one or more layers of the ANN. The pattern may be understood as a distributed activation fingerprint that corresponds to a recognizable computational behavior of the model, and may be determined using one or more operations such as, for example, tracing of activation signals, statistical inference from probabilistic patterns across inputs, pattern matching against known activation signatures stored in a registry, associating activation patterns with identified computational functions, subgraph detection (e.g., based on activation clusters or routing decisions), sparse autoencoder decomposition, or activation clustering based on cosine similarity or functional correlation. The identified internal activation pathway may represent one of several pathways that are simultaneously active during a single inference pass, each associated with a distinct functional role within the network such as factual retrieval, coherence checking, or generative behavior.

At block 606, processing logic generates an output of the artificial neural network based at least in part on the activation data and the constraint set corresponding to the internal activation pathway. Generating the output involves applying the constraint set to evaluate the activation data of the identified internal activation pathway and, where the activation data does not satisfy the constraint set, modulating the activation data to restrict it within the constraints of the constraint set, before the activation pathway is permitted to contribute to the model's final output. The output may take the form of logits representing probability distributions over possible next tokens, intermediate representations passed to subsequent processing stages, or a fully decoded result such as generated text, a classification decision, or an action, depending on the architecture of the artificial neural network, and reflects only those activation contributions that have satisfied or been brought into compliance with their corresponding constraint sets.

In some embodiments, the constraint set comprises at least one of: one or more numeric bounds, one or more activation thresholds, a mask, one or more gating coefficients, one or more sparsity targets, or one or more scaling functions. Numeric bounds may define the permissible minimum and maximum values for activation magnitudes at one or more nodes or layers within the internal activation pathway, establishing the quantitative range within which activations are considered compliant. Activation thresholds may define values that an activation magnitude must meet or must not exceed in order for the pathway to be permitted to contribute to the forward pass, functioning as hard cutoffs that trigger a violation signal when crossed. A mask may be a binary or weighted matrix applied element-wise to the activation tensor that selectively suppresses or zeroes out neurons, features, or connections within the pathway, effectively restricting which portions of the pathway are permitted to contribute to the output. Gating coefficients may be scalar or vector values applied multiplicatively to the activation tensor to modulate the degree to which a given pathway or sub-pathway contributes to the next stage of computation, allowing fine-grained attenuation of pathway influence without fully suppressing it. Sparsity targets may define constraints on the proportion of active neurons or features within the pathway at any given inference step, enforcing a minimum or maximum level of activation density to ensure that the pathway operates within an expected range of computational utilization. Scaling functions may comprise parameterized transformations applied to the activation values of a pathway to normalize, clip, or otherwise reshape the activation distribution, ensuring that the magnitude and variance of pathway activations remain within constraint-compliant ranges throughout the forward pass.

In some embodiments, generating the output comprises evaluating the activation data against the constraint set corresponding to the internal activation pathway to determine whether the activation data satisfies the constraint set, and modulating, in response to determining that the activation data does not satisfy the constraint set, the activation data of the internal activation pathway, wherein the modulation is performed without modifying stored parameters of the artificial neural network. By operating solely on the activation data flowing through the model during inference, rather than on the model's stored weights, the system can correct non-compliant activation behavior in real time on a per-inference or per-token basis while preserving the consistent baseline behavior of the underlying artificial neural network across all subsequent inferences.

In some embodiments, the internal activation pathway comprises one or more activation subgraphs across one or more layers of the artificial neural network, each activation subgraph corresponding to an observed inference behavior of the artificial neural network, and the constraint set comprises one or more constraints assigned to the one or more activation subgraphs based on the observed inference behavior corresponding to each respective activation subgraph. An activation subgraph is a subset of the nodes, weights, and connections within the artificial neural network that are collectively active during a particular inference operation-that is, the specific neurons that fire, the inter-layer connections through which their signals propagate, and the attention heads or expert modules that are engaged-forming an identifiable computational sub-structure within the broader network graph that can be distinguished from other concurrently active sub-structures by its characteristic pattern of activations across layers. Each activation subgraph corresponds to a recognized and/or distinguishable inference behavior, such as factual retrieval, multi-step reasoning, coherence checking, or creative generation, and because different inference behaviors carry different risks and requirements, the constraints assigned to each subgraph may be individually tailored to control that behavior during the forward pass.

In some embodiments, the processing logic is further configured to maintain a registry associating the internal activation pathway or one or more activation subgraphs within the internal activation pathway with a unique identifier, and determining the internal activation pathway comprises referencing the registry based on the activation data to obtain the constraint set that corresponds to the internal activation pathway or the one or more activation subgraphs. The registry serves as a persistent catalog of previously observed and characterized pathways, enabling the processing logic to efficiently look up and apply the appropriate constraint set for each identified pathway at runtime, without dynamically generating new constraints from scratch on every inference, thereby reducing overhead and enabling consistent, reproducible control across repeated inferences.

In some embodiments, the internal activation pathway is one of a plurality of internal activation pathways within the artificial neural network, each of the plurality of internal activation pathways corresponding to a respective constraint set, and generating the output comprises arbitrating among the plurality of internal activation pathways by weighting respective activation data of each of the plurality of internal activation pathways based on satisfaction of the respective constraint set. Because multiple pathways may be active simultaneously during a single inference pass, each contributing to the output in potentially conflicting ways, arbitration ensures that pathways whose activation data more fully satisfies their assigned constraint sets receive proportionally greater influence over the final output, while pathways with more severe violations contribute less or are excluded entirely.

In some embodiments, the internal activation pathway is not associated with a pre-existing constraint set, and the processing logic is further configured to dynamically generate the constraint set for the internal activation pathway based on the activation data observed during the inference. Such dynamically emergent pathways may arise from attention gating patterns, conditional activation clusters, token-dependent subgraph formations, or novel combinations of expert routing decisions in mixture-of-experts architectures that have not been previously cataloged; in these cases the processing logic generates constraints based on observed activation magnitudes, domain alignment analysis, and similarity to known pathways, ensuring that even novel activation behaviors remain subject to control.

In some embodiments, stored context accessed by the artificial neural network during the inference is partitioned into a plurality of segments, and the processing logic is further configured to filter the stored context provided to the internal activation pathway by permitting access to only a subset of the plurality of segments defined by the constraint set corresponding to the internal activation pathway. This pathway-aware memory filtering prevents an internal activation pathway from retrieving stored context that falls outside the scope of its assigned role (for example, preventing a creative-generation pathway from accessing sensitive factual data or preventing a retrieval pathway from drawing on long-term semantic memory that is not relevant to the current input), thereby extending constraint-based control from activation behavior to memory access.

In some embodiments, the constraint set comprises a hierarchical constraint stack including at least a primary constraint and a secondary constraint, wherein the primary constraint comprises a range or threshold of activation among the internal activation pathway, and wherein the secondary constraint comprises a coherence scoring, logical consistency, or tone alignment. By organizing constraints into a hierarchy, the processing logic enforces the most critical safety bounds and activation thresholds first, and evaluates finer-grained behavioral requirements (such as logical consistency or tone alignment) only after the higher-priority primary constraints have been satisfied, ensuring that the most important constraints/rules always take precedence.

In some embodiments, the processing logic is further configured to generate and store a log comprising one or more of: an identification of the internal activation pathway, a result of evaluating the activation data against the constraint set, or a modulation applied to the activation data. This log provides a structured, per-inference record of which pathways were active, whether each pathway's activation data satisfied its assigned constraint set, and what corrective modulation actions were applied, thereby supporting post-hoc interpretability, debugging, regulatory compliance, and audit of the system's runtime decisions.

Unless described otherwise, the operations described with respect to the method and the computing system described herein may be performed automatically, without human input. The processing logic may receive activation data, determine internal activation pathways, evaluate those pathways against constraint sets, modulate non-compliant activation data, arbitrate among concurrent pathways, filter memory access, and generate the output as part of a continuous, automated runtime control process that operates during inference without requiring manual intervention at any step.

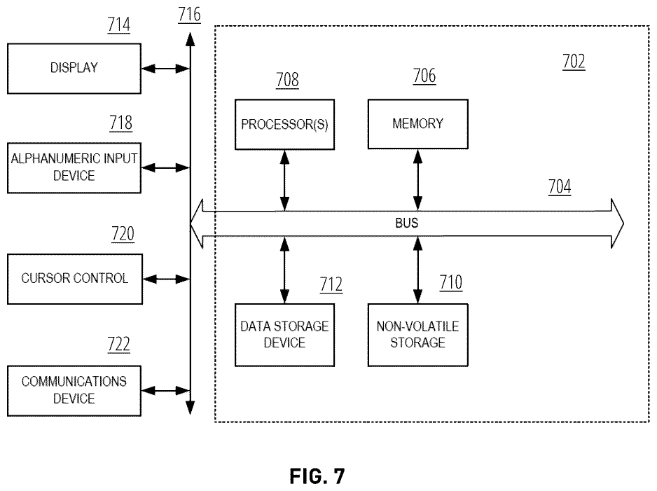

FIG. 7 is one embodiment of a computer system that may be used to support the systems and operations described, in accordance with an embodiment. For example, FIG. 7 may show a computer system and/or processing logic as described in other sections.

The computer system 702 illustrated in FIG. 7 includes a bus or other internal communication means 704 for communicating information, and one or more processors 708 coupled to the bus 704 for processing information. The system further comprises a random access memory (RAM) or other volatile storage device 706 (referred to as memory), coupled to bus 704 for storing information and instructions to be executed by processor 708. Main memory 706 also may be used for storing temporary variables or other intermediate information during execution of instructions by processor 708. The system also comprises a read only memory (ROM), non-volatile storage, and/or static storage device 710 coupled to bus 704 for storing static information and instructions for processor 708, and a data storage device 712 such as a magnetic disk or optical disk and its corresponding disk drive. Data storage device 712 is coupled to bus 704 for storing information and instructions.

The system may further be coupled to a display device 714, such as a light emitting diode (LED) display or a liquid crystal display (LCD) coupled to bus 704 through bus 716 for displaying information to a computer user. An alphanumeric input device 718, including alphanumeric and other keys, may also be coupled to bus 704 through bus 716 for communicating information and command selections to processor 708. An additional user input device is cursor control device 720, such as a touchpad, mouse, a trackball, stylus, or cursor direction keys coupled to bus 704 through bus 716 for communicating direction information and command selections to processor 708, and for controlling cursor movement on display device 714.

Another device, which may optionally be coupled to computer system 702, is a communication device 722 for accessing other nodes of a distributed system via a network. The communication device 722 may include any of a number of commercially available networking peripheral devices such as those used for coupling to an Ethernet, token ring, Internet, or wide area network. The communication device 722 may further be a null-modem connection, or any other mechanism that provides connectivity between the computer system 702 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 706, mass storage device 712, or other storage medium locally or remotely accessible to processor 708.

It will be apparent to those of ordinary skill in the art that the system, method, and process described herein can be implemented as software stored in main memory 706 or read only memory and executed by processor 708. This control logic or software may also be resident on an article of manufacture comprising a computer readable medium having computer readable program code embodied therein and being readable by the mass storage device 712 and for causing the processor 708 to operate in accordance with the methods and teachings herein.

The embodiments discussed herein may also be embodied in a handheld or portable device containing a subset of the computer hardware components described above. For example, the handheld device may be configured to contain only the bus 704, the processor 708, and memory 706 and/or 712. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 708, a data storage device 712, a bus 704, and memory 706, and only rudimentary communications mechanisms, such as a small touch-screen that permits the user to communicate in a basic manner with the device.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

While implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A computing system comprising:
one or more processors; and
a memory storing instructions that, when executed by the one or more processors, configure the system to:
receive, during inference of an artificial neural network processing an input, activation data comprising intermediate numerical representations produced by one or more internal layers of the artificial neural network;
determine, based on the activation data, an internal activation pathway within the artificial neural network, the internal activation pathway corresponding to a constraint set defining permissible activation behavior; and
generate an output of the artificial neural network based at least in part on the activation data and the constraint set corresponding to the internal activation pathway.

2. The computing system of claim 1, wherein the constraint set comprises at least one of: one or more numeric bounds, one or more activation thresholds, a mask, one or more gating coefficients, one or more sparsity targets, or one or more scaling functions.

3. The computing system of claim 1, wherein to generate the output comprises:
evaluating the activation data against the constraint set corresponding to the internal activation pathway to determine whether the activation data satisfies the constraint set; and
modulating, in response to determining that the activation data does not satisfy the constraint set, the activation data of the internal activation pathway, wherein the modulation is performed without modifying stored parameters of the artificial neural network.

4. The computing system of claim 1, wherein the internal activation pathway comprises one or more activation subgraphs across one or more layers of the artificial neural network, each activation subgraph corresponding to an observed inference behavior of the artificial neural network, and wherein the constraint set comprises one or more constraints assigned to the one or more activation subgraphs based on the observed inference behavior corresponding to each respective activation subgraph.

5. The computing system of claim 1, wherein the system is further configured to:
maintain a registry associating the internal activation pathway or one or more activation subgraphs within the internal activation pathway with a unique identifier, and wherein to determine the internal activation pathway comprises referencing the registry based on the activation data to obtain the constraint set that corresponds to the internal activation pathway or the one or more activation subgraphs.

6. The computing system of claim 1, wherein the internal activation pathway is one of a plurality of internal activation pathways within the artificial neural network, each of the plurality of internal activation pathways corresponding to a respective constraint set, and wherein to generate the output comprises arbitrating among the plurality of internal activation pathways by weighting respective activation data of each of the plurality of internal activation pathways based on satisfaction of the respective constraint set.

7. The computing system of claim 1, wherein the internal activation pathway is not associated with a pre-existing constraint set, and wherein the system is further configured to dynamically generate the constraint set for the internal activation pathway based on the activation data observed during the inference.

8. The computing system of claim 1, wherein stored context accessed by the artificial neural network during the inference is partitioned into a plurality of segments, and wherein the system is further configured to filter the stored context provided to the internal activation pathway by permitting access to a subset of the plurality of segments defined by the constraint set corresponding to the internal activation pathway.

9. The computing system of claim 1, wherein the constraint set comprises a hierarchical constraint stack including at least a primary constraint and a secondary constraint, wherein the primary constraint comprises a range or threshold of activation among the internal activation pathway, and wherein the secondary constraint comprises a coherence scoring, logical consistency, or tone alignment.

10. The computing system of claim 1, wherein the system is further configured to generate and store a log comprising one or more of: an identification of the internal activation pathway, a result of evaluating the activation data against the constraint set, or a modulation applied to the activation data.

11. A method, performed by a processing device, comprising:
receiving, during inference of an artificial neural network processing an input, activation data comprising intermediate numerical representations produced by one or more internal layers of the artificial neural network;
determining, based on the activation data, an internal activation pathway within the artificial neural network, the internal activation pathway corresponding to a constraint set defining permissible activation behavior; and
generating an output of the artificial neural network based at least in part on the activation data and the constraint set corresponding to the internal activation pathway.

12. The method of claim 11, wherein the constraint set comprises at least one of: one or more numeric bounds, one or more activation thresholds, a mask, one or more gating coefficients, one or more sparsity targets, or one or more scaling functions.

13. The method of claim 11, wherein generating the output comprises:
evaluating the activation data against the constraint set corresponding to the internal activation pathway to determine whether the activation data satisfies the constraint set; and
modulating, in response to determining that the activation data does not satisfy the constraint set, the activation data of the internal activation pathway, wherein the modulation is performed without modifying stored parameters of the artificial neural network.

14. The method of claim 11, wherein the internal activation pathway comprises one or more activation subgraphs across one or more layers of the artificial neural network, each activation subgraph corresponding to an observed inference behavior of the artificial neural network, and wherein the constraint set comprises one or more constraints assigned to the one or more activation subgraphs based on the observed inference behavior corresponding to each respective activation subgraph.

15. The method of claim 11, further comprising:
maintaining a registry associating the internal activation pathway or one or more activation subgraphs within the internal activation pathway with a unique identifier, and wherein determining the internal activation pathway comprises referencing the registry based on the activation data to obtain the constraint set that corresponds to the internal activation pathway or the one or more activation subgraphs.

16. A non-transitory computer readable medium storing instructions that, when executed by one or more processors, cause the one or more processors to:
receive, during inference of an artificial neural network processing an input, activation data comprising intermediate numerical representations produced by one or more internal layers of the artificial neural network;
determine, based on the activation data, an internal activation pathway within the artificial neural network, the internal activation pathway corresponding to a constraint set defining permissible activation behavior; and
generate an output of the artificial neural network based at least in part on the activation data and the constraint set corresponding to the internal activation pathway.

17. The non-transitory computer readable medium of claim 16, wherein the constraint set comprises at least one of: one or more numeric bounds, one or more activation thresholds, a mask, one or more gating coefficients, one or more sparsity targets, or one or more scaling functions.

18. The non-transitory computer readable medium of claim 16, wherein to generate the output comprises:
evaluating the activation data against the constraint set corresponding to the internal activation pathway to determine whether the activation data satisfies the constraint set; and
modulating, in response to determining that the activation data does not satisfy the constraint set, the activation data of the internal activation pathway, wherein the modulation is performed without modifying stored parameters of the artificial neural network.

19. The non-transitory computer readable medium of claim 16, wherein the internal activation pathway comprises one or more activation subgraphs across one or more layers of the artificial neural network, each activation subgraph corresponding to an observed inference behavior of the artificial neural network, and wherein the constraint set comprises one or more constraints assigned to the one or more activation subgraphs based on the observed inference behavior corresponding to each respective activation subgraph.

20. The non-transitory computer readable medium of claim 16, wherein the instructions further cause the one or more processors to:
maintain a registry associating the internal activation pathway or one or more activation subgraphs within the internal activation pathway with a unique identifier, and wherein to determine the internal activation pathway comprises referencing the registry based on the activation data to obtain the constraint set that corresponds to the internal activation pathway or the one or more activation subgraphs.
